(19) United States
(12) Patent Application Publication
(10) Pub. No.: US 2011/0222013 A1
(43) Pub. Date: Sep. 15, 2011

(54) LIQUID CRYSTAL DISPLAY DEVICE AND MANUFACTURING METHOD THEREOF

(75) Inventors: Hiroyuki Kawanishi, Osaka-shi (JP); Hisashi Nagata, Osaka-shi (JP); Naoto Kondo, Osaka-shi (JP)

(73) Assignee: SHARP KABUSHIKI KAISHA, Osaka-shi, Osaka (JP)

(21) Appl. No.: 13/127,509

(22) PCT Filed: Sep. 1, 2009
(86) PCT No.: PCT/JP2009/004290

§ 371 Date: May 4, 2011

(30) Foreign Application Priority Data
Nov. 20, 2008 (JP) 2008-296408

(51) Int. Cl. G02F 1/1339

(52) U.S. Cl. 349/153; 349/190

(57) ABSTRACT

A liquid crystal display device includes: first and second substrates placed so as to face each other; a frame-shaped sealing member provided between the first and second substrates, and configured to bond the first and second substrate together; and a liquid crystal layer formed by enclosing a liquid crystal material inside the sealing member. A display region configured to display an image is defined inside the sealing member, and a non-display region is defined outside the display region. The non-display region is also provided in an inner periphery of the sealing member. The first substrate is provided with a plurality of wall-shaped portions formed in the non-display region in the inner periphery of the sealing member so as to extend along the sealing member and to be separated from each other.

### TECHNICAL FIELD

The present invention relates to liquid crystal display (LCD) devices and manufacturing methods thereof.

### BACKGROUND ART

In LCD devices, a pair of substrates are bonded together via a frame-shaped sealing member so as to face each other. A liquid crystal layer is provided inside the sealing member, and a display region for displaying an image is defined inside the sealing member. A so-called one drop filling (ODF) method is known as a method for manufacturing such an LCD device. The ODF method is a method in which a sealing member is formed in a frame shape on one of a pair of substrates, and a predetermined amount of liquid crystal material is dropped by a dispenser onto a region surrounded by the sealing member on the substrate, and the pair of substrates are bonded together in an evacuated processing chamber.

In manufacturing of the LCD devices by the ODF method, the sealing member is cured after the pair of substrates are bonded together via a liquid crystal material dropped onto a region inside the uncured sealing member. Thus, the liquid crystal material is spread out toward the uncured sealing member when the pair of substrates are bonded together. If the liquid crystal material has sufficient viscosity, the liquid crystal material does not immediately spread out to the sealing member even when the pair of substrates are pressed to have a predetermined cell gap therebetween. Thus, in the region inside the sealing member, an area near the sealing member is in a vacuum state. If a curing process such as ultraviolet (UV) radiation is performed on the sealing member while the area near the sealing member is in the vacuum state, the sealing member is sufficiently cured before the liquid crystal material eventually reaches the sealing member.

In fact, however, the liquid crystal material contacts the uncured sealing member during the pressing process for bonding the pair of substrates together or the curing process for curing the sealing member. Thus, the uncured sealing member is contained in the liquid crystal layer, which tends to reduce display quality due to stain display defects, etc. Moreover, due to a change in component of the sealing member, the sealing member tends to collapse even after being cured between the pair of substrates, and defective curing of the sealing member tends to occur.

As a solution to this problem, Patent Document 1, for example, discloses formation of a partition wall that separates a liquid crystal layer from a sealing member along the sealing member. The partition wall is formed in a frame shape on one of substrates of an LCD device so as to surround the entire liquid crystal layer, thereby reducing the possibility of contact between the sealing member and the liquid crystal material.

### CITATION LIST

### Patent Document

PATENT DOCUMENT 1: Japanese Patent Publication No. 2008-26566

### SUMMARY OF THE INVENTION

### Technical Problem

However, in the case where the frame-shaped partition wall surrounding the entire liquid crystal layer is formed so as to adjoin the display region as in the LCD device of Patent Document 1, fine vacuum portions in the form of air bubbles tend to remain in the liquid crystal layer in the display region, if the amount of dropped liquid crystal material is smaller than a proper amount according to the volume inside the partition wall due to variation in the dropping amount of the dispenser. Such vacuum portions tend to reduce display quality, and there remains room for improvement.

The present invention was developed in view of the above problems, and it is an object of the present invention to reduce the possibility that a liquid crystal material may contact an uncured sealing member, and to reduce the possibility that vacuum portions in the form of air bubbles may remain in a liquid crystal layer in a display region.

### Solution to the Problem

In order to achieve the above object, according to the present invention, a non-display region is also provided in the inner periphery of a sealing member, and one substrate is provided with a plurality of wall-shaped portions formed in the non-display region in the inner periphery of the sealing member so as to extend along the sealing member and to be separated from each other.

Specifically, an LCD device of the present invention includes: first and second substrates placed so as to face each other; a frame-shaped sealing member provided between the first and second substrates, and configured to bond the first and second substrate together; and a liquid crystal layer formed by enclosing a liquid crystal material inside the sealing member, where a display region configured to display an image is defined inside the sealing member, and a non-display region is defined outside the display region, wherein the non-display region is also provided in an inner periphery of the sealing member, and the first substrate is provided with a plurality of wall-shaped portions formed in the non-display region in the inner periphery of the sealing member so as to extend along the sealing member and to be separated from each other.

In the above configuration, in manufacturing of the LCD device, the sealing member is formed in a frame shape over the first substrate, the liquid crystal material is dropped onto a region inside the sealing member in the first substrate, which will serve as the display region, and then the first and second substrates are bonded together. At this time, the wall-shaped portions obstruct spreading of the liquid crystal material to the portions of the sealing member along which the wall-shaped portions extend. This reduces the possibility that the liquid crystal material may contact the sealing member before the sealing member is cured.

After the sealing member is cured, the sealing member spreads out to the sealing member through the gap between the wall-shaped portions. Thus, even if the amount of dropped liquid crystal material is smaller than a proper amount, vacuum portions in the form of air bubbles remain in the non-display region near the sealing member, which is filled with the liquid crystal material after the display region. In the region near the sealing member where the vacuum portions in the form of air bubbles remain, the thickness of the liquid crystal layer is less likely to change due to vibrations, impacts, etc. Thus, the vacuum portions in the form of air bubbles are relatively less likely to move to the display region. Accordingly, the possibility is reduced that the liquid crystal material may contact the uncured sealing member, and that the vacuum portions in the form of air bubbles may remain in the liquid crystal layer in the display region.

Incidentally, in a so-called polymer stabilized alignment (PSA) technique, a polymerizable component (such as a monomer or an oligomer), which is polymerized by UV radiation, is added in advance to a liquid crystal material. A predetermined voltage is applied to a liquid crystal layer to tilt liquid crystal molecules, and the polymerizable component is polymerized in this state. Thus, the liquid crystal molecules have a stable pretilt angle due to the action of the resultant polymer. In LCD devices using this PSA technique, contact of the liquid crystal material with an uncured sealing member may result in abnormal growing of the polymer and an abnormal pretilt angle of the liquid crystal molecules when a process of curing the sealing member is performed, or when the polymerizable component is irradiated with UV light.

However, according to the LCD device of the present invention, the possibility is reduced that the liquid crystal material may contact the uncured sealing member. Thus, the possibility of abnormal growing of the polymer in the liquid crystal material and the abnormal pretilt angle of the liquid crystal molecules is reduced even when the PSA technique is used. Thus, display quality can be reliably increased by the PSA technique.

It is preferable that the wall-shaped portions be provided so as to be separated from the sealing member.

In this configuration as well, the wall-shaped portions obstruct spreading of the liquid crystal material to the portions of the sealing member along which the wall-shaped portions extend, when the first and second substrates are bonded together via the liquid crystal material dropped inside the uncured sealing member. Since spreading of the liquid crystal material to these portions of the sealing member is retarded, the possibility is reduced that the liquid crystal material may contact the sealing member before the sealing member is cured.

After the sealing member is cured, the liquid crystal material spreads out through the gaps between the wall-shaped portions into the gaps between the wall-shaped portions and the sealing member, which will serve as the non-display region. Thus, even if the amount of dropped liquid crystal material is smaller than a proper amount, vacuum portions in the form of air bubbles remain in the gaps between the wall-shaped portions and the sealing member, which are filled with the liquid crystal material after the display region. In the region near the sealing member where the vacuum portions in the form of air bubbles remain, the thickness of the liquid crystal layer is less likely to change due to vibrations, impacts, etc., and the wall-shaped portions are placed on the side of the display region. Thus, the vacuum portions in the form of air bubbles are very unlikely to move to the display region. Accordingly, the possibility is reduced that the liquid crystal material may contact the uncured sealing member, and the possibility is satisfactorily reduced that the vacuum portions in the form of air bubbles may remain in the liquid crystal layer in the display region.

It is preferable that the sealing member be formed in a rectangular frame shape, and have a pair of first sides extending in one direction, and a pair of second sides extending in a direction perpendicular to the first sides, and that the plurality of wall-shaped portions have at least one pair of first wall-shaped portions facing each other along the first sides, and at least one pair of second wall-shaped portions facing each other along the second sides.

With the above configuration, by dropping the liquid crystal material onto a region surrounded by the pair of first wall-shaped portions and the pair of second wall-shaped portions in the step of dropping the liquid crystal material onto the display region of the first substrate in manufacturing of the LCD device, the wall-shaped portions (the first and second wall-shaped portions) obstruct spreading of the liquid crystal material to the portions of the sides (the first and second sides) of the sealing member which are located near the dropped position of the liquid crystal material. Thus, the possibility is satisfactorily reduced that the liquid crystal material may contact the sides of the uncured sealing member.

It is preferable that the sealing member be formed in a rectangular frame shape, and that the plurality of wall-shaped portions have a pair of corner wall-shaped portions extending in directions perpendicular to each other along at least one corner of the sealing member.

With the above configuration as well, by dropping the liquid crystal material onto a region inside the pair of corner wall-shaped portions in the step of dropping the liquid crystal material onto the display region of the first substrate in manufacturing of the LCD device, the corner wall-shaped portions obstruct spreading of the liquid crystal material to the corner of the sealing member which is located near the dropped position of the liquid crystal material. Thus, the possibility is satisfactorily reduced that the liquid crystal material may contact the uncured sealing member. As used herein, the “region inside the pair of corner wall-shaped portions” refers to a region defined at a position located on the opposite side of the corner wall-shaped portions from the portions of the sealing member along which the pair of corner wall-shaped portions extend.

Upper surfaces of the wall-shaped portions need not necessarily be in contact with the second substrate, but is preferably in contact with the second substrate.

With the above configuration, the possibility is reduced that the liquid crystal material may spread out over the wall-shaped portions to the sealing member when the first and second substrates are bonded together. Thus, the possibility is satisfactorily reduced that the liquid crystal material may contact the uncured sealing member.

It is preferable that the wall-shaped portions be spacers configured to maintain a thickness of the liquid crystal layer.

With the above configuration, the step of forming the spacers need not be performed separately from the step of forming the wall-shaped portions. Thus, the number of manufacturing steps need not be increased to form the wall-shaped portions, whereby manufacturing cost is reduced.

Moreover, in the case where columnar spacers are formed separately from the wall-shaped portions serving as spacers, the thickness of the liquid crystal layer may vary between the outer peripheral portion and the central portion of the display region due to the difference in height between the wall-shaped portions and the spacers. However, in the above configuration, no spacers need be formed separately from the wall-shaped portions, which reduces the possibility of variation in thickness of the liquid crystal layer.

Moreover, it is preferable to specifically use the following configurations so that the number of manufacturing steps need not be increased to form the wall-shaped portions.

It is preferable that the first substrate be provided with a columnar spacer configured to maintain a thickness of the liquid crystal layer, and that the wall-shaped portions be made of a same material as the spacer.

In the above configuration, the wall-shaped portions can be formed simultaneously with the spacers. Thus, the number of manufacturing steps need not be increased to form the wall-shaped portions, whereby manufacturing cost is reduced.

It is preferable that the first substrate be a color filter substrate having color filters of a plurality of colors, and that the wall-shaped portions be formed by stacking the color filters of different colors together.

In the above configuration, the wall-shaped portions can be formed simultaneously with the color filters of the plurality of colors. Thus, the number of manufacturing steps need not be increased to form the wall-shaped portions, whereby the manufacturing cost is reduced.

A method for manufacturing an LCD device according to the present invention is a method for manufacturing an LCD device including first and second substrates placed so as to face each other, a frame-shaped sealing member provided between the first and second substrates, and configured to bond the first and second substrate together, and a liquid crystal layer formed by enclosing a liquid crystal material inside the sealing member, where a display region configured to display an image is defined inside the sealing member, and a non-display region is defined outside the display region. The method includes: a wall-shaped portion formation step of fabricating the first substrate by forming a plurality of wall-shaped portions over the substrate in which a frame-shaped seal region configured to place the sealing member therein is defined, so that the wall-shaped portions extend along the seal region in a region, which is to be a part of the non-display region, in an inner periphery of the seal region, and are separated from each other; a sealing member formation step of forming the sealing member in the seal region of the first substrate; a dropping step of dropping the liquid crystal material onto a region, which is to be the display region, in the first substrate having the wall-shaped portions and the sealing member formed thereon; and a bonding step of bonding the first and second substrate together via the sealing member and the liquid crystal material, and curing the sealing member.

According to the above manufacturing method, in the wall-shaped portion formation step, the plurality of wall-shaped portions are formed over the first substrate in which the frame-shaped seal region configured to place the sealing member therein is defined, so that the wall-shaped portions extend along the seal region in the region, which is to be a part of the non-display region, in the inner periphery of the seal region, and are separated from each other. Thus, when the first and second substrates are bonded together in the bonding step, the wall-shaped portions obstruct spreading of the liquid crystal material to the portions of the sealing member along which the wall-shaped portions extend. This reduces the possibility that the liquid crystal material may contact the sealing member before the sealing member is cured.

After the sealing member is cured in the bonding step, the liquid crystal material spreads out to the sealing member through the gap between the wall-shaped portions. Accordingly, even if the amount of dropped liquid crystal material is smaller than a proper amount in the dropping step, vacuum portions in the form of air bubbles remain in the non-display region near the sealing member which is filled with the liquid crystal material after the display region. In the region near the sealing member where the vacuum portions in the form of air bubbles remain, the thickness of the liquid crystal layer is less likely to change due to vibrations, impacts, etc. Thus, the vacuum portions in the form of air bubbles are relatively less likely to move to the display region. Accordingly, the possibility is reduced that the liquid crystal material may contact the uncured sealing member, and the possibility is satisfactorily reduced that the vacuum portions in the form of air bubbles may remain in the liquid crystal layer in the display region.

According to the manufacturing method of the present invention, since the possibility is reduced that the liquid crystal material may contact the uncured sealing member, the possibility of abnormal growing of the polymer in the liquid crystal material and the abnormal pretilt angle of the liquid crystal molecules is reduced even when the so-called PSA technique is used. Thus, the display quality can be reliably increased by the PSA technique.

It is preferable that the seal region be defined in a rectangular frame shape, and have a pair of first side regions extending in one direction, and a pair of second side regions extending in a direction perpendicular to the first side regions, that at least one pair of first wall-shaped portions facing each other along the first side regions, and at least one pair of second wall-shaped portions facing each other along the second side regions be formed in the wall-shaped portion formation step, and that the liquid crystal material be dropped onto a region surrounded by the pair of first wall-shaped portions and the pair of second wall-shaped portions in the dropping step.

According to the above manufacturing method, the wall-shaped portions (the first and second wall-shaped portions) obstruct spreading of the liquid crystal material to the portions of the sides of the sealing member which are located near the dropped position of the liquid crystal material. Thus, the possibility is satisfactorily reduced that the liquid crystal material may contact the sides of the uncured sealing member.

It is preferable that the seal region be defined in a rectangular frame shape, that a pair of corner wall-shaped portions, which extend in directions perpendicular to each other along at least one corner of the seal region, be formed in the wall-shaped formation step, and that the liquid crystal material be dropped onto a region inside the pair of corner wall-shaped portions in the dropping step.

According to the above manufacturing method as well, the wall-shaped portions obstruct spreading of the liquid crystal material to the corner of the sealing member which is located near the dropped position of the liquid crystal material. Thus, the possibility is satisfactorily reduced that the liquid crystal material may contact the uncured sealing member.

### Advantages of the Invention

According to the present invention, the non-display region is also provided in the inner periphery of the sealing member, and the plurality of wall-shaped portions are provided in the non-display region in the inner periphery of the sealing member on the first substrate so as to extend along the sealing member and to be separated from each other. This can reduce the possibility that the liquid crystal material may contact the uncured sealing member, and also reduce the possibility that the vacuum portions in the form of air bubbles may remain in the liquid crystal layer in the display region. As a result, display quality of the LCD device can be increased, and the possibility of defective products due to collapse of the sealing member and defective curing can be reduced.

### BRIEF DESCRIPTION OF THE DRAWINGS

FIG. 1 is a plan view schematically showing an LCD device of a first embodiment.

FIG. 2 is a cross-sectional view taken along line II-II in FIG. 1, schematically showing a part of the LCD device.

FIG. 3 is a plan view schematically showing a color filter substrate having wall-shaped portions formed thereon.

FIG. 4 is a cross-sectional view taken along line IV-IV in FIG. 3, schematically showing a part of the color filter substrate.

FIG. 5 is a plan view schematically showing the color filter substrate having a sealing member formed thereon.

FIG. 6 is a cross-sectional view taken along line VI-VI in FIG. 5, schematically showing a part of the color filter substrate.

FIG. 7 is a plan view schematically showing the color filter substrate having a liquid crystal material dropped thereon.

FIG. 8 is a plan view schematically showing the state where the color filter substrate is bonded to a thin film transistor substrate.

FIG. 9 is a cross-sectional view taken along line IX-IX in FIG. 8, schematically showing the state where the color filter substrate is bonded to the thin film transistor substrate.

FIG. 10 is a cross-sectional view schematically showing a part of an LCD device of a second embodiment.

FIG. 11 is a cross-sectional view schematically showing a part of an LCD device of a third embodiment.

FIG. 12 is a cross-sectional view schematically showing a part of an LCD device of a fourth embodiment.

FIG. 13 is a plan view schematically showing an LCD device of a fifth embodiment.

FIG. 14 is a plan view schematically showing a color filter substrate having a liquid crystal material dropped thereon according to the fifth embodiment.

FIG. 15 is a plan view schematically showing an LCD device of another embodiment.

### DESCRIPTION OF EMBODIMENTS

Embodiments of the present invention will be described in detail below with reference to the accompanying drawings. Note that the present invention is not limited to the following embodiments.

### First Embodiment

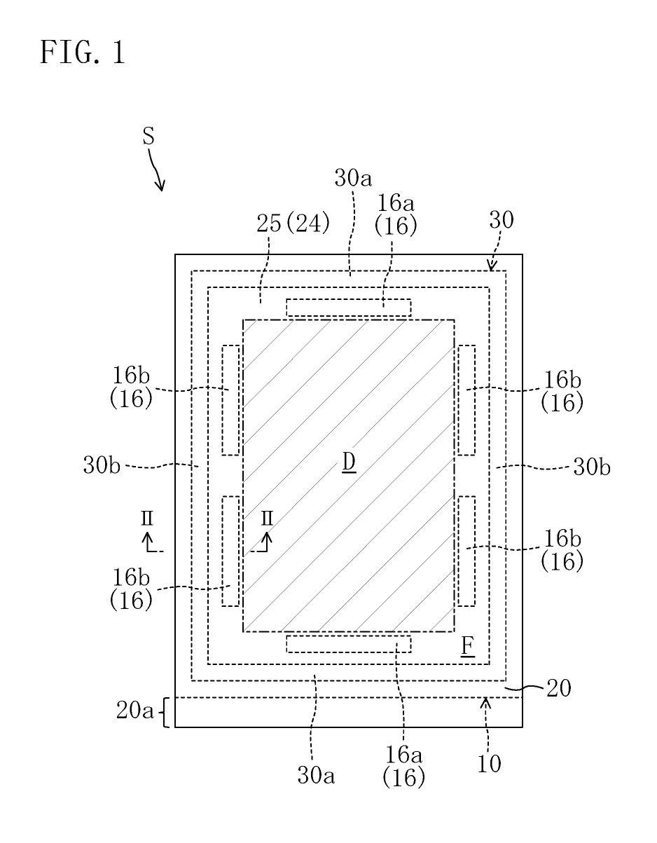

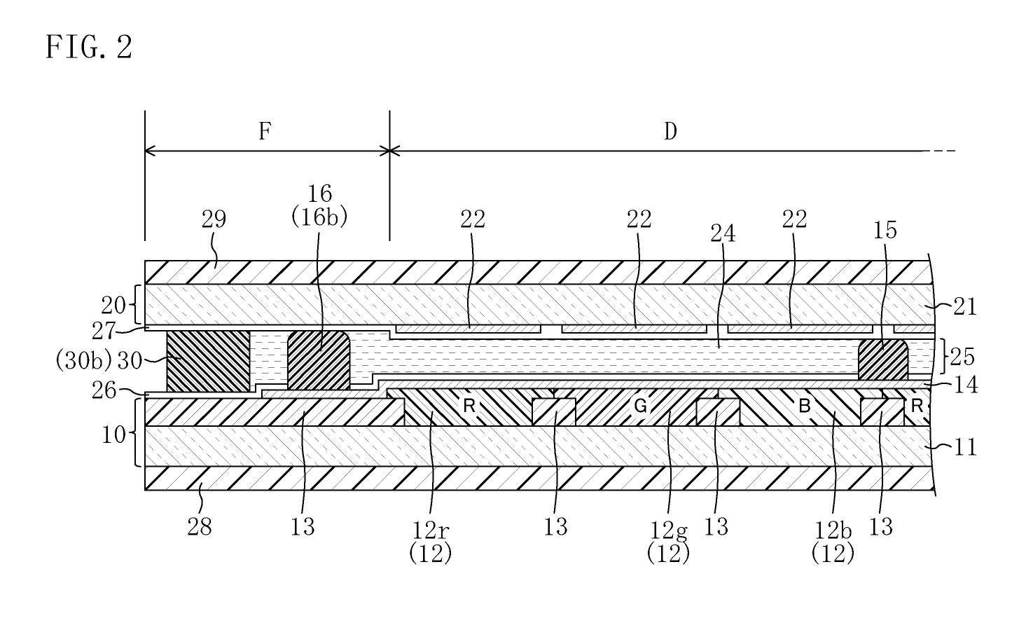

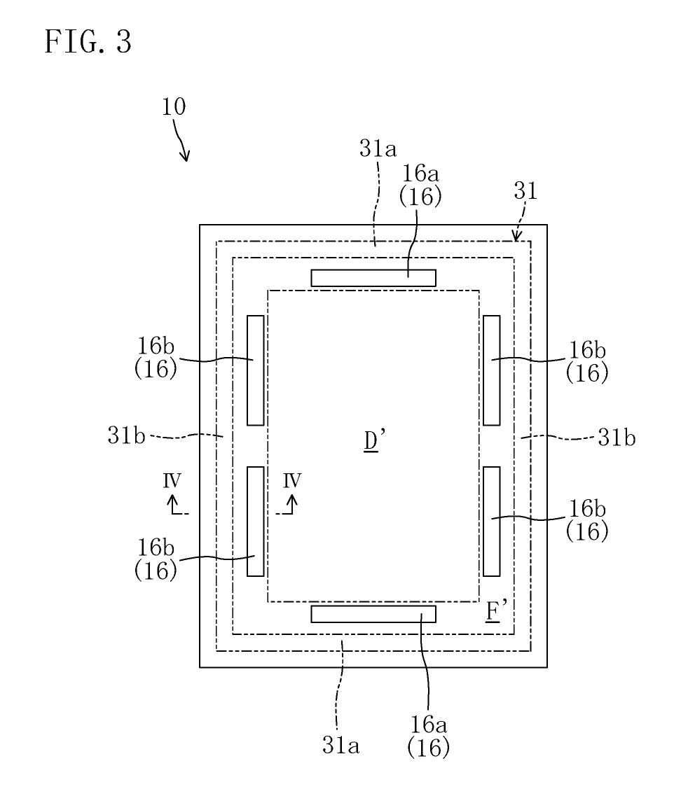

FIGS. 1 to 9 show a first embodiment of an LCD device according to the present invention. FIG. 1 is a plan view schematically showing an LCD device S of the present embodiment as viewed from the side of a thin film transistor (TFT) substrate 20. FIG. 2 is a cross-sectional view taken along line II-II in FIG. 1, schematically showing a part of the LCD device S. FIGS. 3 to 9 are diagrams illustrating a manufacturing method of the LCD device S described below.

As shown in FIGS. 1 and 2, the LCD device S includes a color filter substrate 10 as a first substrate and a TFT substrate 20 as a second substrate, which are placed so as to face each other, and a liquid crystal layer 25 provided between the color filter substrate 10 and the TFT substrate 20. A display region D, which is formed by a plurality of pixels and configured to display an image, is defined, and a non-display region F is defined outside the display region D.

As shown in FIG. 1, the color filter substrate 10 and the TFT substrate 20 are formed in, e.g., a rectangular shape. As shown in FIG. 2, alignment films 26 and 27 are provided on the surfaces of the color filter substrate 10 and the TFT substrate 20 which are located on the side of the liquid crystal layer 25, and polarizing plates 28 and 29 are provided on the opposite sides of the color filter substrate 10 and the TFT substrate 20 from the liquid crystal layer 25. A sealing member 30 is placed between the color filter substrate 10 and the TFT substrate 20, and both substrates 10 and 20 are bonded together by the sealing member 30.

As shown in FIG. 1, the sealing member 30 is formed in, e.g., a rectangular frame shape so as to extend along the outer edge of the color filter substrate 10. The sealing member 30 has a pair of first sides 30a extending in the shorter side direction (the lateral direction in the figure) of the color filter substrate 10, and a pair of second sides 30b extending in the longer side direction (the vertical direction in the figure) perpendicular to the first sides 30a. As shown in FIGS. 1 and 2, in the LCD device S, the display region D is defined inside the sealing member 30. On the other hand, the non-display region F is provided both outside the sealing member 30 and in the inner periphery of the sealing member 30.

In the LCD device S, the liquid crystal layer 25 is formed by enclosing the liquid crystal material 24 inside the sealing member 30. The liquid crystal layer 25 contains a polymer, and liquid crystal molecules have a stable pretilt angle due to the action of the polymer. That is, since a so-called polymer stabilized alignment (PSA) technique is used in the LCD device S of the present embodiment, the response time of the liquid crystal molecules is relatively short when displaying an image, and alignment disorder of the liquid crystal molecules is less likely to occur.

As shown in FIG. 2, the color filter substrate 10 has a glass substrate 11, and color filters 12 of a plurality of colors are arranged in a matrix pattern on the glass substrate 11 so as to correspond to the pixels. The color filters 12 of the plurality of colors are formed by, e.g., color filters 12r, 12g, and 12b of three colors, namely red, green, and blue, and these color filters 12r, 12g, and 12b are periodically arranged in the row direction.

A black matrix 13 is provided in the color filter substrate 10 so as to separate the color filters 12 from each other, and a common electrode 14, which is made of indium tin oxide (ITO), etc., is formed so as to cover the color filters 12. A plurality of columnar spacers 15, which are made of a resin material, etc., are provided at predetermined intervals on the common electrode 14 so as to overlap the black matrix 13. The upper surfaces of the spacers 15 are in contact with the TFT substrate 20, thereby maintaining the thickness of the liquid crystal layer 25.

As shown in FIG. 1, in the color filter substrate 10, a plurality of wall-shaped portions 16 are provided in the non-display region F in the inner periphery of the sealing member 30 so as to extend along the sealing member 30 and to be separated from each other. The plurality of wall-shaped portions 16 are formed by a pair of first wall-shaped portions 16a facing each other along the first sides 30a of the sealing member 30, and two pairs of second wall-shaped portions 16b facing each other along the second sides 30b of the sealing member 30.

The wall-shaped portions 16 are arranged according to the positions where the liquid crystal material is to be dropped in a dropping step described later. Specifically, the pair of first wall-shaped portions 16a are provided along the central portions of the first sides 30a. The two pairs of second wall-shaped portions 16b are provided next to each other along the second sides 30b. The two pairs of second wall-shaped portions 16b are respectively positioned in two regions of the non-display region F in the inner periphery of the sealing member 30, which are divided at the center of the length of the non-display region F in the direction in which the second sides 30b extend.

The wall-shaped portions 16 are provided so as to be separated from the sealing member 30, and a gap is formed between each wall-shaped portion 16 and the sealing member 30. The gaps between the wall-shaped portions 16 and the sealing member 30 are also filled with the liquid crystal material 24. As shown in FIG. 2, the wall-shaped portions 16 are made of the same resin material as the spacers 15, and the upper surfaces of the wall-shaped portions 16 are in contact with the TFT substrate 20. Thus, the wall-shaped portions 16 together with the spacers 15 maintain the thickness of the liquid crystal layer 25.

The TFT substrate 20 has a glass substrate 21 shown in FIG. 2, and although not shown in the figures, a plurality of source lines and a plurality of gate lines are provided over the glass substrate 21 so that the source lines extend parallel to each other, and the gate lines extend parallel to each other in a direction perpendicular to the source lines. The source lines and the gate lines are formed so as to define the regions that form the pixels. A thin film transistor (TFT) and a pixel electrode 22 shown in FIG. 2 are provided in each of the regions that form the pixels. The TFTs are provided near the intersections of the source lines and the gate lines, and each TFT is connected to the source line and the gate line that form a corresponding one of the intersections, and each pixel electrode 22 is connected to a corresponding one of the TFTs.

As shown in FIG. 1, the TFT substrate 20 has a larger area and is longer in one direction (the vertical direction in the figure) than the color filter substrate 10, and has a mount portion 20a protruding outward beyond the color filter substrate 10. Although not shown in the figures, a drive circuit chip configured to drive the TFTs, etc., a flexible printed wiring board configured to supply power to the drive circuit chip and to supply signals from an external circuit to the color filter substrate 10 and the TFT substrate 20, etc., are mounted on the mount portion 20a.

Thus, the LCD device S sequentially write a predetermined amount of charge to the pixel electrodes 22 via the TFTs according to a predetermined input signal from the external circuit, and applies a predetermined voltage to the liquid crystal layer 25 between the pixel electrodes 22 and the common electrode 14. In this manner, the LCD device S controls alignment of the liquid crystal molecules on a pixel-by-pixel basis to display a desired image on the display region D.

[Manufacturing Method]

A manufacturing method of the LCD device S will be described below with reference to FIGS. 3 to 9.

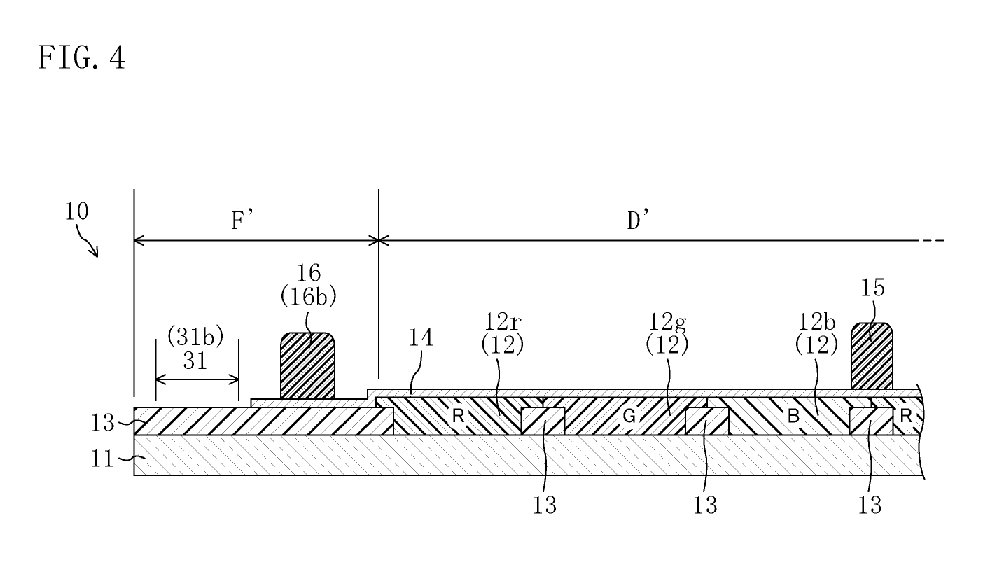

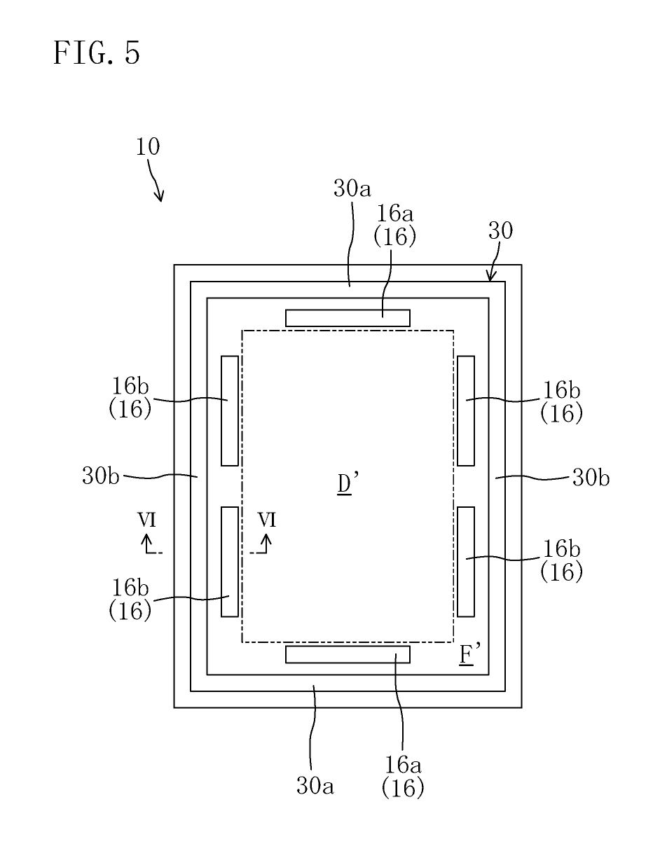

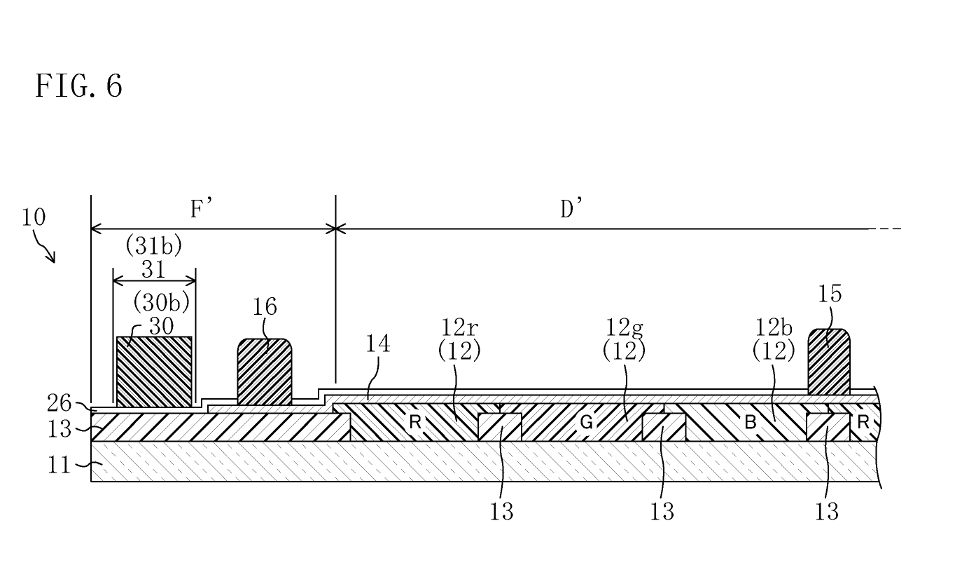

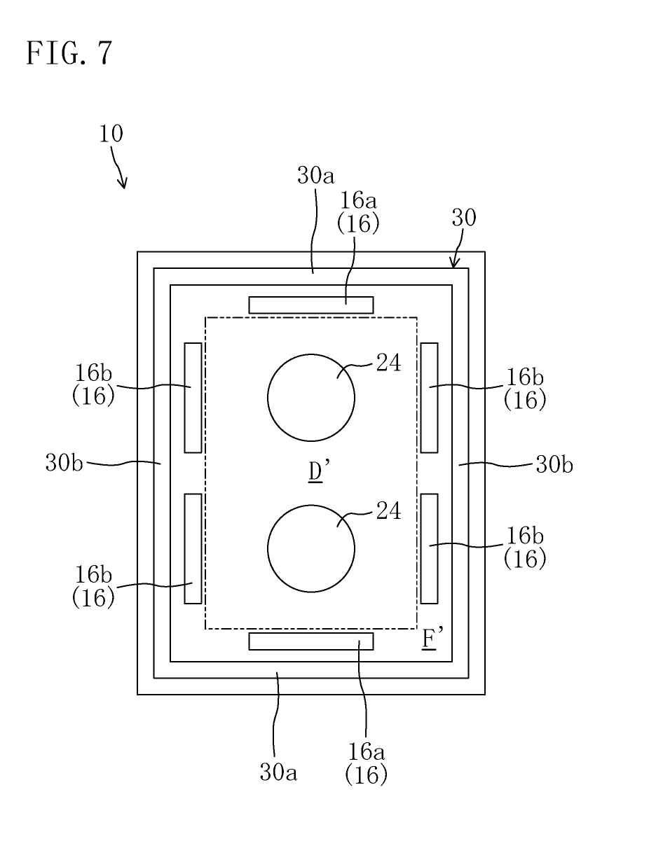

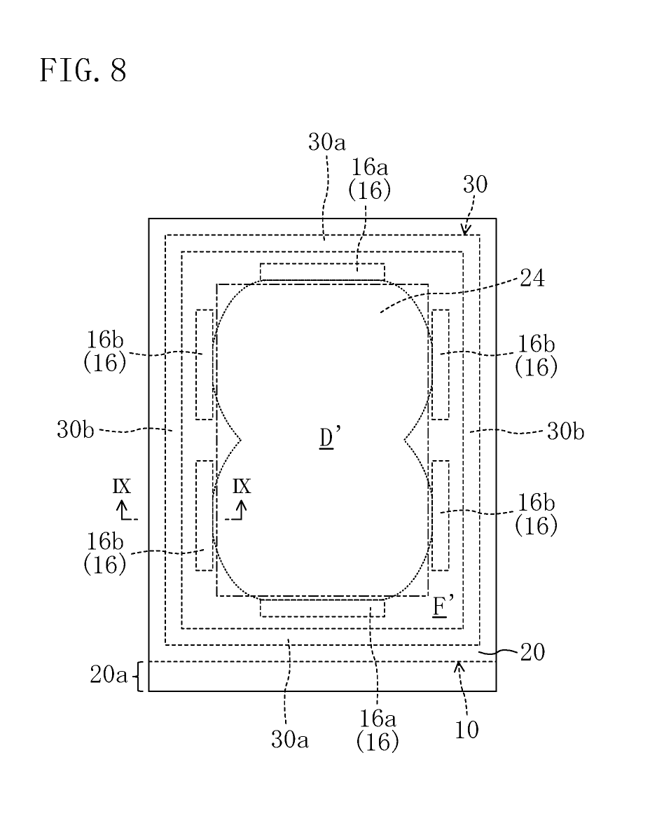

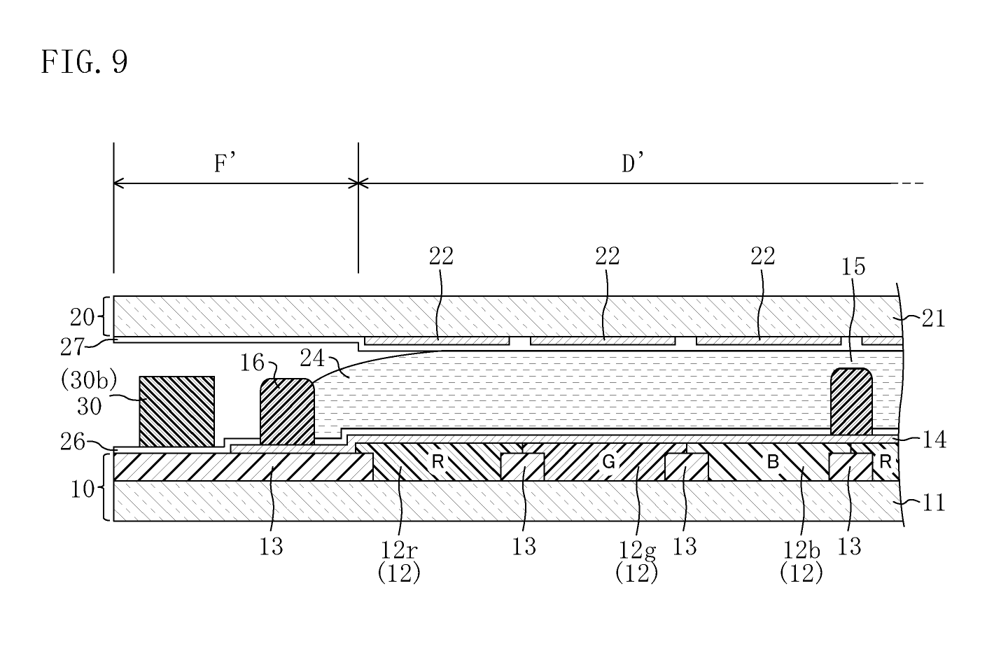

FIG. 3 is a plan view schematically showing the color filter substrate 10 having the wall-shaped portions 16 formed thereon. FIG. 4 is a cross-sectional view taken along line IV-IV in FIG. 3, schematically showing the color filter substrate 10. FIG. 5 is a plan view schematically showing the color filter substrate 10 having the sealing member 30 formed thereon. FIG. 6 is a cross-sectional view taken along line VI-VI in FIG. 5, schematically showing the color filter substrate 10. FIG. 7 is a plan view schematically showing the color filter substrate 10 having the liquid crystal material 24 dropped thereon. FIG. 8 is a plan view schematically showing the state where the color filter substrate 10 is bonded to the TFT substrate 20. FIG. 9 is a cross-sectional view taken along line IX-IX in FIG. 8, schematically showing the state where the color filter substrate 10 is bonded to the TFT substrate 20.

The manufacturing method of the LCD device S of the present embodiment includes a wall-shaped formation step, a sealing member formation step, a dropping step, and a bonding step.

First, two glass substrates 11 and 21, each having a rectangular frame-shaped seal region 31 (shown in FIG. 3 described later) defined therein, are prepared. The seal region 31 is a region for placing a sealing member 30 so that a region F′, which is to be a non-display region F, is also provided in the inner periphery of the sealing member 30. The seal region 31 has a pair of first side regions 31a for placing first sides 30a of the sealing member 30, and a pair of second side regions 30b for placing second sides 30b of the sealing member 30.

Next, as shown in FIG. 4, a black matrix 13, color filters 12 of each color, a common electrode 14, etc. are sequentially formed on one of the glass substrates, namely the glass substrate 11. Then, the wall-shaped portion formation step is performed.

In the wall-shaped portion formation step, a resin material having a photosensitive property is applied to the surface of the common electrode 14 by a spin coating method, etc. Then, as shown in FIG. 3, prebaking, exposure, development using an alkaline solution, etc., and postbaking are performed to form wall-shaped portions 16 in the region F′, which is to be a part of the non-display region F in the inner periphery of the seal region 31, so that the wall-shaped portions 16 extend along the seal region 31 and are separated from each other. That is, a pair of first wall-shaped portions 16a are formed along the first side regions 31a so as to face each other, and two pairs of second wall-shaped portions 16b are formed along the second side regions 31b so as to face each other. At this time, as shown in FIG. 4, spacers 15 are also formed together with the wall-shaped portions 16. The color filter substrate 10 is fabricated in this manner. Then, an alignment film 26 is formed on the surface of the color filter substrate 10 by a printing method, etc.

Interconnects (such as source lines and gate lines), TFTs, pixel electrodes 22, etc. are formed over the other glass substrate 21 to fabricate a TFT substrate 20. Then, an alignment film 27 is formed on the surface of the TFT substrate 20 by a printing method, etc.

In the subsequent sealing member formation step, as shown in FIGS. 5 and 6, an uncured sealing member 30 containing, e.g., an epoxy resin and an acrylic resin and having both thermosetting and UV-curable properties is formed in a rectangular frame shape in the seal region 31 of the color filter substrate 10 by writing with a dispenser or by a screen printing method.

In the subsequent dropping step, a predetermined amount of liquid crystal material 24, which contains a polymerizable component (such as a monomer or an oligomer) that is polymerized by UV radiation, is dropped from a dispenser onto a region D′, which is to be a display region D, of the color filter substrate 10 having the wall-shaped portions 16 and the sealing member 30 formed thereon. Specifically, in the present embodiment, as shown in FIG. 7, the liquid crystal material 24 is dropped onto two regions surrounded by the pair of first wall-shaped portions 16a and the pairs of second wall-shaped portions 16b, namely onto a region surrounded by the pair of first wall-shaped portions 16a and one of the pairs of second wall-shaped portions 16b, and a region surrounded by the pair of first wall-shaped portions 16a and the other pair of second wall-shaped portions 16b.

In the subsequent bonding step, both substrates 10 and 20 are first aligned in an evacuated processing chamber so that the regions D′ of the color filter substrate 10 and the TFT substrate 20, which are to be the display region D, overlap each other. The substrates 10 and 20 are bonded together via the liquid crystal material 24 dropped inside the uncured sealing member 30. Then, the substrates 10 and 20 are pressed to bring the spacers 15 and the wall-shaped portions 16 into contact with the TFT substrate 20, so that the substrates 10 and 20 have a predetermined cell gap therebetween. At this time, as shown in FIGS. 8 and 9, the liquid crystal material 24 is spread out between the substrates 10 and 20 in a concentric circular pattern about the dropped positions of the liquid crystal material 24 toward the uncured sealing member 30.

Then, the sealing member 30 is cured by UV radiation, and is completely cured by heating, whereby the color filter substrate 10 is bonded to the TFT substrate 20. The liquid crystal material 24 is thus enclosed between the pair of substrates 10 and 20 by the sealing member 30, whereby a liquid crystal layer 25 is formed.

Thereafter, a predetermined signal is supplied to the pixel electrodes 22 and the common electrode 14 to apply a predetermined voltage to the liquid crystal layer 25 between the pixel electrodes 22 and the common electrode 14, thereby tilting liquid crystal molecules at a predetermined angle. With the liquid crystal molecules being tilted in this manner, the liquid crystal layer 25 is irradiated with UV light to polymerize the polymerizable component in the liquid crystal material 24. Thus, the liquid crystal molecules have a stable pretilt angle due to the action of the polymer thus produced.

Subsequently, polarizing plates 28 and 29 are attached to the outer surfaces of the substrates 10 and 20 that are bonded together, and a drive circuit chip, a flexible printed wiring board, etc. are mounted on a mount portion 20a of the TFT substrate 20, whereby the LCD device S is completed.

### Advantages of First Embodiment

Thus, according to the LCD device S of the first embodiment, the non-display region F is also provided in the inner periphery of the sealing member 30. In the color filter substrate 10, the plurality of wall-shaped portions 16, which is formed by the pair of first wall-shaped portions 16a and the two pairs of wall-shaped portions 16b, are provided in the non-display region F in the inner periphery of the sealing member 30 so as to extend along the sealing member 30 and to be separated from each other. According to the manufacturing method of the LCD device S, in the partition wall formation step, the wall-shaped portions 16a and 16b are formed over the substrate in which the frame-shaped seal region 31 configured to place the sealing member 30 therein is defined, so that the wall-shaped portions 16a and 16b are located in the region F′, which is to be a part of the non-display region F, in the inner periphery of the seal region 31. The color filter substrate 10 is formed in this manner. Then, in the sealing member formation step, the sealing member 30 is formed over the color filter substrate 10, and in the subsequent dropping step, the liquid crystal material 24 is dropped onto the regions surrounded by the pair of first wall-shaped portions 16a and the pairs of second wall-shaped portions 16b. Thus, as shown in FIGS. 8 and 9, when the color filter substrate 10 is bonded to the TFT substrate 20 in the subsequent bonding step, the wall-shaped portions 16a and 16b obstruct spreading of the liquid crystal material 24 to the portions of the sides 30a and 30b of the sealing member 30 which are located near the dropped positions of the liquid crystal material 24. Thus, spreading of the liquid crystal material 24 to the sealing member 30 can be retarded. At this time, since the upper surfaces of the wall-shaped portions 16 is in contact with the TFT substrate 20, the possibility can be reduced that the liquid crystal material 24 may spread out over the wall-shaped portions 16 to the sealing member 30. Thus, the possibility can be satisfactorily reduced that the liquid crystal material 24 may contact the sides 30a and 30b of the sealing member 30 before the sealing member 30 is cured by UV radiation.

The wall-shaped portions 16 are provided so as to be separated from the sealing member 30. Thus, after the sealing member 30 is cured by UV radiation, the liquid crystal material 24 spreads out through the gaps between the wall-shaped portions 16 into the gaps between the wall-shaped portions 16 and the sealing member 30, which will serve as the non-display region F. Accordingly, even if the amount of dropped liquid crystal material 24 is smaller than a proper amount due to variation in the dropping amount of the dispenser, etc., vacuum portions in the form of air bubbles remain in the gaps between the wall-shaped portions 16 and the sealing member 30, which are filled with the liquid crystal material 24 after the display region D. In the region near the sealing member 30 where the vacuum portions in the form of air bubbles remain, the thickness of the liquid crystal layer 25 is less likely to change due to vibrations and impacts. Moreover, the wall-shaped portions 16 are placed on the side of the display region D. Thus, the vacuum portions in the form of air bubbles are very unlikely to move to the display region D.

This can reduce the possibility that the liquid crystal material 24 may contact the uncured sealing member 30, and can satisfactorily reduce the possibility that the vacuum portions in the form of air bubbles may remain in the liquid crystal layer 25 in the display region D. Since the possibility can be reduced that the uncured sealing member 30 may be contained in the liquid crystal layer 25, and that the vacuum portions in the form of air bubbles may remain in the liquid crystal layer 25 in the display region D, display quality of the LCD device S can be increased, and the possibility of defective products due to collapse of the sealing member 30 after curing between the substrates 10 and 20, and defective curing of the sealing member 30 can be reduced.

Incidentally, in LCD devices using the so-called PSA technique, contact of the liquid crystal material 24 with the uncured sealing member 30 may result in abnormal growing of the polymer and an abnormal pretilt angle of the liquid crystal molecules when a process of curing the sealing member 30 is performed, or when the polymerizable component is irradiated with UV light. However, in the LCD device S of the present embodiment, the possibility of contact of the liquid crystal material 24 with the uncured sealing member 30 can be reduced, whereby the possibility of abnormal growing of the polymer in the liquid crystal material 24 and the abnormal pretilt angle of the liquid crystal molecules can be reduced. Thus, the display quality can be reliably increased by the PSA technique.

The wall-shaped portions 16 are made of the same resin material as the spacers 15, and are formed simultaneously with the spacers 15 in the wall-shaped portion formation step. Thus, the number of manufacturing steps is not increased to form the wall-shaped portions 16, and the manufacturing cost can be reduced.

### Second Embodiment

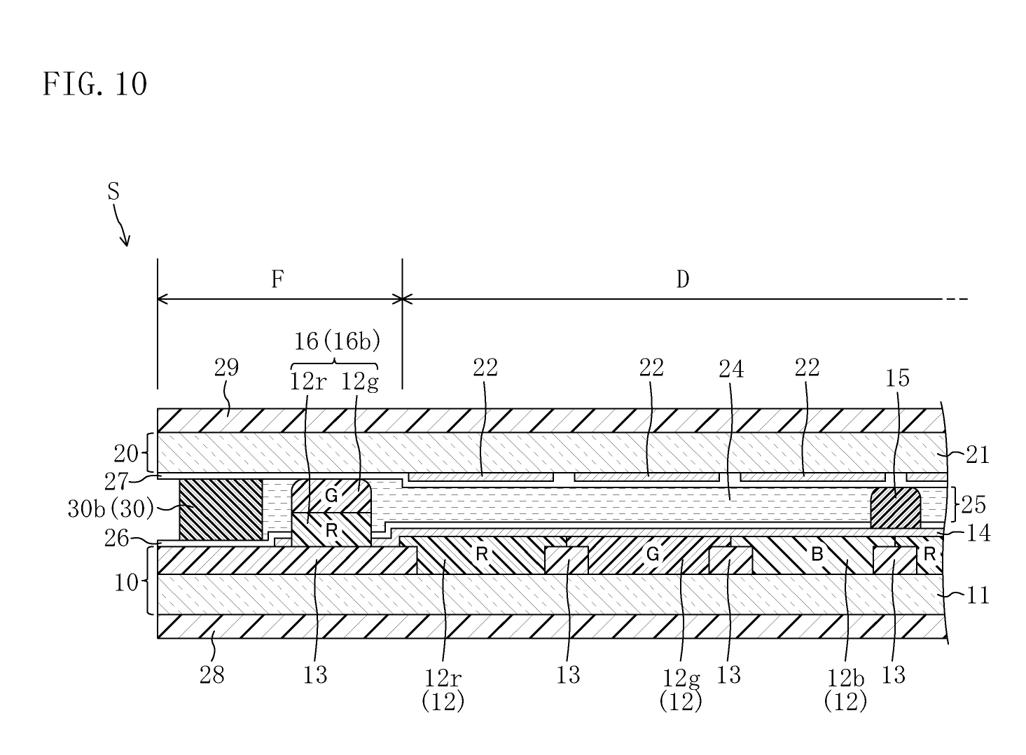

FIG. 10 shows a second embodiment of the LCD device S of the present invention. Note that in the following embodiments, the same portions as those of FIGS. 1 to 9 are denoted with the same reference characters, and detailed description thereof will be omitted. FIG. 10 is a cross-sectional view schematically showing a part (a part corresponding to FIG. 2) of the LCD device S of the present embodiment.

Although the wall-shaped portions 16 are made of the same resin material as the spacers 15 in the first embodiment, the wall-shaped portions 16 are formed by staking the color filters 12 of different colors together in the present embodiment. Specifically, as shown in FIG. 10, the wall-shaped portions 16 of the present embodiment are formed by sequentially stacking the red and green color filters 12r and 12g together. As in the first embodiment, the wall-shaped portions 16 are provided so as to be separated from the sealing member 30, and the upper surfaces of the wall-shaped portions 16 are in contact with the TFT substrate 20.

In order to manufacture this LCD device S, the red, green, and blue color filters 12r, 12g, and 12b are first sequentially formed in fabrication of the color filter substrate 10. At this time, the red color filters 12r are formed both in the display region D and in the regions where the wall-shaped portions 16 are to be positioned. Moreover, the green color filters 12g are formed in the display region D, and also stacked on the red color filters 12r formed in the regions where the wall-shaped portions 16 are to be positioned. The wall-shaped portions 16 are formed in this manner. That is, the wall-shaped portion formation step of the present embodiment is performed after the black matrix 13 described in the first embodiment is formed, and the wall-shaped portions 16 are formed simultaneously with the color filters 12r and 12g of the plurality of colors.

Note that in the present embodiment, the wall-shaped portions 16 are formed by stacking the red and green color filters 12r and 12g together. However, the wall-shaped portions 16 may be formed by stacking the green and blue color filters 12g and 12b together, or by stacking the color filters 12 in other color combinations as appropriate according to the order in which the color filters 12r, 12g, and 12b of each color are formed. The color filters 12 that form the wall-shaped portions 16 are not limited to two colors, and the wall-shaped portions 16 may be formed by sequentially stacking the color filters 12r, 12g, and 12b of all the three colors together so as to have a desired height.

Since the wall-shaped portions 16 have a larger volume than the spacers 15, the wall-shaped portions 16 are less likely to be compressed between the substrates 10 and 20 than the spacers 15. The predetermined cell gap is formed between the color filter substrate 10 and the TFT substrate 20 in the state where the spacers 15 are compressed therebetween. Thus, if the wall-shaped portions 16 are formed to have the same height as the spacers 15, the thickness of the liquid crystal layer 25 may vary between the outer peripheral portion and the central portion of the display region D. Accordingly, it is preferable that the wall-shaped portions 16 be formed so as to be slightly lower than the spacers 15.

Then, the common electrode 14 is formed so as to cover the color filters 12, whereby the color filter substrate 10 is fabricated. Thereafter, the TFT substrate 20 is fabricated in a manner similar to that of the first embodiment, and the sealing member formation step, the dropping step, and the bonding step are performed.

### Advantages of Second Embodiment

Thus, in the second embodiment as well, the possibility can be reduced that the liquid crystal material 24 may contact the uncured sealing member 30 and the vacuum portions in the form of air bubbles may remain in the liquid crystal layer 25 in the display region D when the color filter substrate 10 is bonded to the TFT substrate 20 in the bonding step. Moreover, since the wall-shaped portions 16 are formed simultaneously with the color filters 12r and 12g of the plurality of colors, the number of manufacturing steps is not increased to form the wall-shaped portions 16, and the manufacturing cost can be reduced.

### Third Embodiment

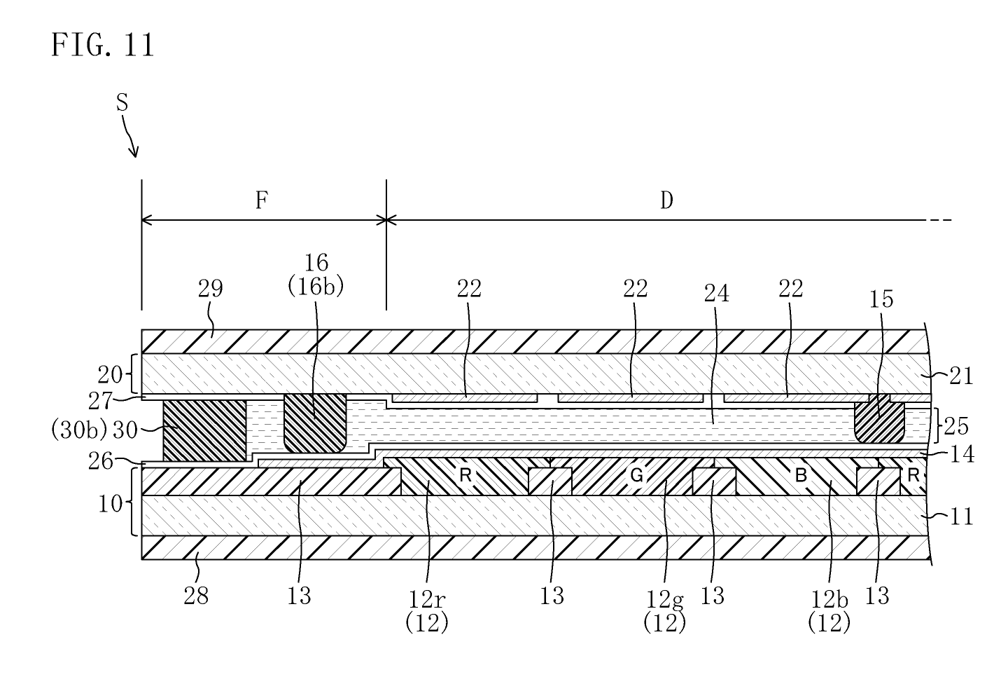

FIG. 11 shows a third embodiment of the LCD device S of the present invention. FIG. 11 is a cross-sectional view schematically showing a part (a part corresponding to FIG. 2) of the LCD device S of the present embodiment.

In the above embodiments, the color filter substrate 10 is the first substrate, the TFT substrate 20 is the second substrate, and the wall-shaped portions 16 are provided over the color filter substrate 10. However, in the present embodiment, the TFT substrate 20 is the first substrate, the color filter substrate 10 is the second substrate, and as shown in FIG. 11, the wall-shaped portions 16 are provided over the TFT substrate 20.

The wall-shaped portions 16 are formed so as to be located at positions similar to those of the first embodiment between the color filter substrate 10 and the TFT substrate 20, and the upper surfaces of the wall-shaped portions 16 are in contact with the color filter substrate 10. The spacers 15, which are formed over the color filter substrate 10 in the first embodiment, are formed over the TFT substrate 20 of the present embodiment so as to overlap the black matrix 13.

In order to manufacture the LCD device S, in fabrication of the TFT substrate 20, the pixel electrodes 22 are formed, and then a resin material having a photosensitive property is applied by a spin coating method, etc. so as to cover the pixel electrodes 22. Thereafter, prebaking, exposure, development using an alkaline solution, etc., and postbaking are performed to form the wall-shaped portions 16 and the spacers 15. The TFT substrate 20 having the wall-shaped portions 16 is fabricated in this manner.

Moreover, the color filter substrate 10 is fabricated which has a configuration similar to that of the first embodiment except that neither the spacers 15 nor the wall-shaped portions 16 are formed thereon. Then, in the sealing member formation step, the uncured sealing member 30 is formed in a rectangular frame shape over the TFT substrate 20, and in the dropping step, a predetermined amount of liquid crystal material 24 is dropped onto the display region D of the TFT substrate 20 having the sealing member 30 formed thereon. Subsequently, in the bonding step, the color filter substrate 10 is bonded to the TFT substrate 20, and the sealing member 30 is cured.

### Advantages of Third Embodiment

Thus, in the third embodiment as well, the wall-shaped portions 16 are formed on the TFT substrate 20 so as to be located at positions similar to those of the first embodiment between the color filter substrate 10 and the TFT substrate 20. Accordingly, the possibility can be reduced that the liquid crystal material 24 may contact the uncured sealing member 30 and the vacuum portions in the form of air bubbles may remain in the liquid crystal layer 25 in the display region D when the color filter substrate 10 is bonded to the TFT substrate 20 in the bonding step. Moreover, since the wall-shaped portions 16 are formed simultaneously with the spacers 15 in the wall-shaped formation step, the number of manufacturing steps is not increased to form the wall-shaped portions 16, and the manufacturing cost can be reduced.

### Fourth Embodiment

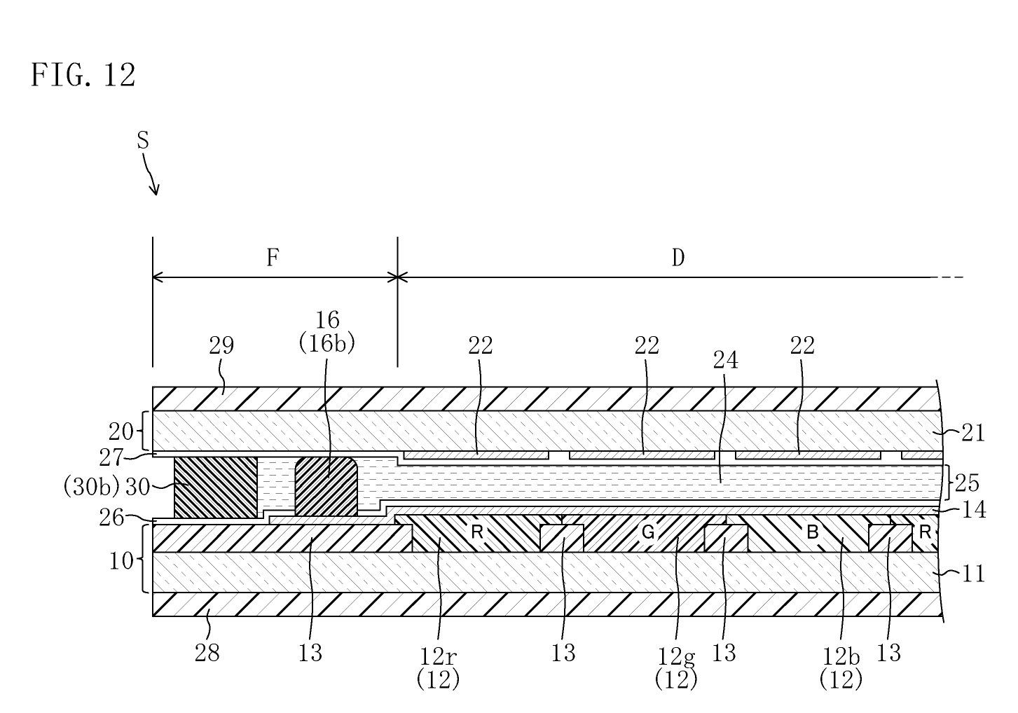

FIG. 12 shows a fourth embodiment of the LCD device S of the present invention. FIG. 12 is a cross-sectional view schematically showing a part (a part corresponding to FIG. 2) of the LCD device S of the present embodiment.

In the first embodiment, the thickness of the liquid crystal layer 25 is maintained by the spacers 15 and the wall-shaped portions 16. In the present embodiment, however, as shown in FIG. 12, only the wall-shaped portions 16 serve as spacers that maintain the thickness of the liquid crystal layer 25.

A method for manufacturing this LCD device S includes the wall-shaped portion formation step, the sealing member formation step, the dropping step, and the bonding step, and is similar to the method of the first embodiment except that no columnar spacers 15 are formed simultaneously with the wall-shaped portions 16 in the wall-shaped portion formation step. Thus, description thereof will be omitted.

### Advantages of Fourth Embodiment

Thus, in the fourth embodiment as well, the possibility can be reduced that the liquid crystal material 24 may contact the uncured sealing member 30 and the vacuum portions in the form of air bubbles may remain in the liquid crystal layer 25 in the display region D when the color filter substrate 10 is bonded to the TFT substrate 20 in the bonding step. Moreover, since the step of forming the spacers is not required separately from the step of forming the wall-shaped portions 16, the number of manufacturing steps is not increased to form the wall-shaped portions 16, and the manufacturing cost can be reduced.

In addition, in the case where columnar spacers are formed separately from the wall-shaped portions 16 serving as spacers, the thickness of the liquid crystal layer 25 may vary between the outer peripheral portion and the central portion of the display region D due to the difference in height between the wall-shaped portions 16 and the spacers. However, according to the LCD device S of the present embodiment, no spacers need be formed separately from the wall-shaped portions 16. This can reduce the possibility of variation in thickness of the liquid crystal layer 25.

### Fifth Embodiment

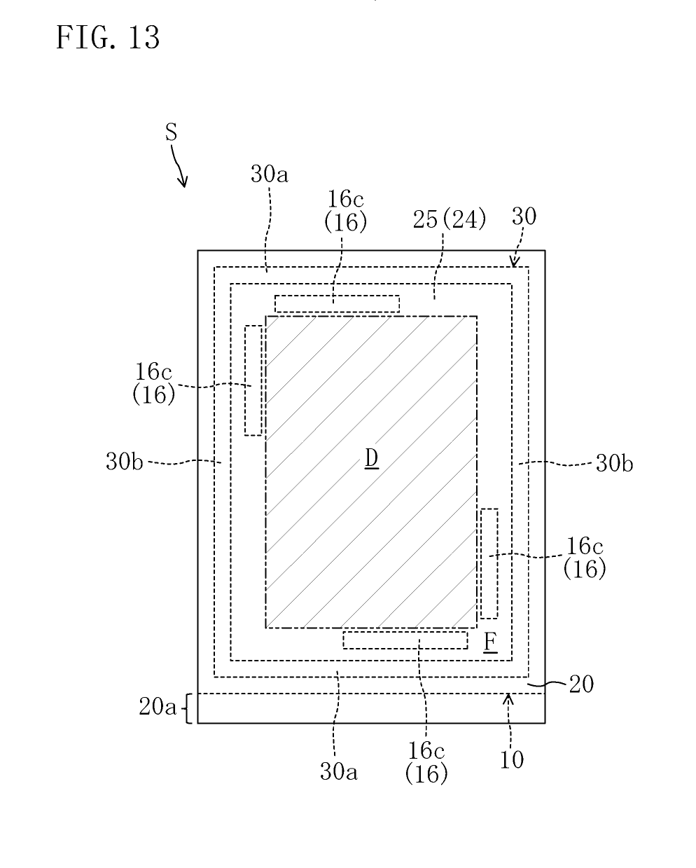

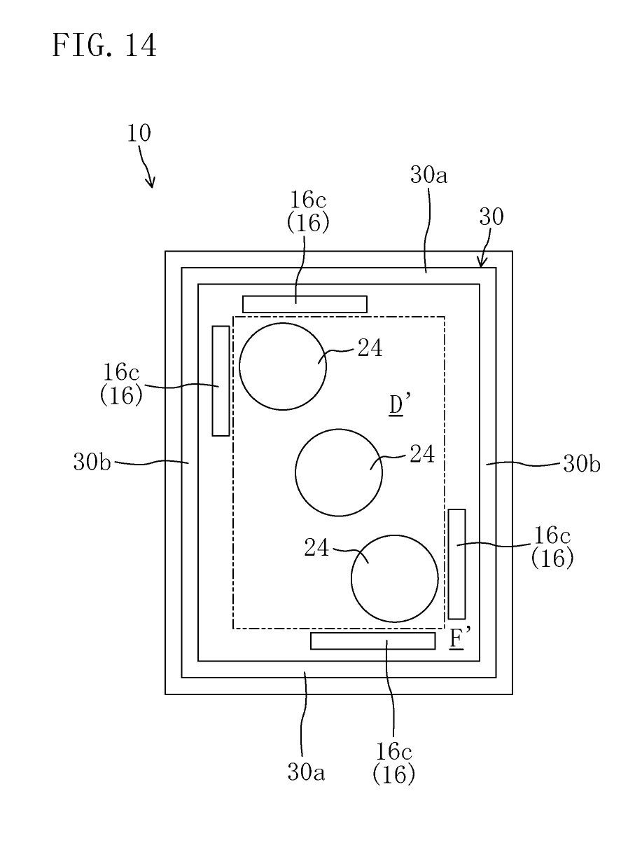

FIGS. 13 and 14 show a fifth embodiment of the LCD device S of the present invention. FIG. 13 is a plan view schematically showing the LCD device S of the present embodiment. FIG. 14 is a plan view schematically showing the color filter substrate 10 having the liquid crystal material 24 dropped thereon in the present embodiment.

In the first embodiment, the plurality of wall-shaped portions 16 have the pair of first wall-shaped portions 16a facing each other along the first sides 30a of the sealing member 30, and the two pairs of second wall-shaped portions 16b facing each other along the second sides 30b of the sealing member 30. In the present embodiment, however, as shown in FIG. 13, the plurality of wall-shaped portions 16 have two pairs of corner wall-shaped portions 16c extending in directions perpendicular to each other along corners of the sealing member 30. The pairs of corner wall-shaped portions 16c are provided along, e.g., one pair of opposing corners (the upper left corner and the lower right corner in FIG. 13) of the sealing member 30. Like the first embodiment, the pairs of corner wall-shaped portions 16c are formed so as to be separated from the sealing member 30, and the upper surfaces of the corner wall-shaped portions 16c are in contact with the TFT substrate 20.

Note that in the present embodiment, the two pairs of wall-shaped portions 16c are provided along the one pair of opposing corners of the sealing member 30. However, the pairs of corner wall-shaped portions 16c may be provided along all of the four corners of the sealing member 30, or along only one corner of the sealing member 30.

In order to manufacture this LCD device S, the wall-shaped portions 16 are formed in the wall-shaped portion formation step in a manner similar to that of the first embodiment except the positions where the wall-shaped portions 16 are formed. That is, in the wall-shaped portion formation step, the two pairs of corner wall-shaped portions 16c are formed so as to extend in the directions perpendicular to each other along one pair of opposite corners of the seal region 31. At this time, the spacers 15 are formed together with the wall-shaped portions 16. The color filter substrate 10 is fabricated in this manner, and the alignment film 26 is then formed over the surface of the color filter substrate 10.

The dropping step is performed after fabricating the TFT substrate 20, forming the alignment film 27 over the surface of the TFT substrate 20, and performing the sealing member formation step in a manner similar to that of the first embodiment. In the dropping step of the present embodiment, as shown in FIG. 14, a predetermined amount of liquid crystal material 24 is dropped from a dispenser onto the regions inside the pairs of corner wall-shaped portions 16c, and onto the central portion of the region D′ that is to be the display region D. As used herein, the “region inside the pair of corner wall-shaped portions 16c” refers to the region defined at the position located on the opposite side of the corner wall-shaped portions 16c from the portion of the sealing member 30 along which the corner wall-shaped portions 16c extend. Thereafter, the bonding step is performed in a manner similar to that of the first embodiment.

### Advantages of Fifth Embodiment

Thus, in the fifth embodiment as well, the pairs of corner wall-shaped portions 16c obstruct spreading of the liquid crystal material to the corners of the sealing member 30 which are located near the dropped positions of the liquid crystal material 24 when the color filter substrate 10 is bonded to the TFT substrate 20 in the bonding step. Accordingly, the possibility can be satisfactorily reduced that the liquid crystal material 24 may contact the uncured sealing member 30, and the possibility can be reduced that the vacuum portions in the form of air bubbles may remain in the liquid crystal layer 25 in the display region D. Moreover, since the wall-shaped portions 16 are formed simultaneously with the spacers 15, the number of manufacturing steps is not increased to form the wall-shaped portions 16, and the manufacturing cost can be reduced.

### Other Embodiments

In the first embodiment, the wall-shaped portions 16 are provided so as to be separated from the sealing member 30. However, the present invention is not limited to this, and the wall-shaped portions 16 may be provided so as to contact the sealing member 30. In this configuration as well, the wall-shaped portions 16 obstruct spreading of the liquid crystal material to the portions of the sealing member 30 along which the wall-shaped portions 16 extend, when the color filter substrate 10 is bonded to the TFT substrate 20. This can reduce the possibility that the liquid crystal material 24 may contact the sealing member 30 before the sealing member 30 is cured by UV radiation.

After the sealing member 30 is cured by UV radiation, the liquid crystal material 24 spreads out to the sealing member 30 through the gaps between the wall-shaped portions 16. Thus, even if the amount of dropped liquid crystal material 24 is smaller than a proper amount, vacuum portions in the form of air bubbles remain in the non-display region F near the sealing member 30, which is filled with the liquid crystal material 24 after the display region D. In the region near the sealing member 30 where the vacuum portions in the form of air bubbles remain, the thickness of the liquid crystal layer 25 is less likely to vary due to vibrations, impacts, etc. Thus, these vacuum portions are relatively less likely to move to the display region D. This can reduce the possibility that the liquid crystal material 24 may contact the uncured sealing member 30, and thus reduce the possibility that the vacuum portions in the form of air bubbles may remain in the liquid crystal layer 25 in the display region D.

Incidentally, in the case where the wall-shaped portions 16 are provided so as to contact the sealing member 30 as described above, the portions of the sealing member 30 along which the wall-shaped portions 16 extend hardly spread inward but spread substantially only outward and squash due to the wall-shaped portions 16, when the color filter substrate 10 is bonded to the TFT substrate 20 via the sealing member 30 and the liquid crystal material 24 in manufacturing of the LCD device S. Thus, these portions of the sealing member 30 are less likely to squash than the remaining portion of the sealing member 30 along which no wall-shaped portions 16 extend. Accordingly, the thickness of the liquid crystal layer 25 may vary between the areas near the wall-shaped portions 16 and the remaining area in the display region D.

Thus, in the case where the wall-shaped portions 16 are provided so as to contact the sealing member 30, it is preferable to tilt the side faces of the wall-shaped portions 16 located on the side of the sealing member 30 to a relatively great extent so that the upper parts of the side faces are located closer to the display region D, by adjusting as appropriate the wavelength of light used to expose a resin material for forming the wall-shaped portions 16, and the temperature and time of postbaking performed after developing the resin material. In this case, due to the tilting of the side faces of the wall-shaped portions 16 located on the side of the sealing member 30, the sealing member 30, including the portions of the sealing member 30 along which the wall-shaped portions 16 extend, satisfactorily spreads inward as well when the color filter substrate 10 is bonded to the TFT substrate 20. Since the sealing member 30 spreads both inward and outward and squashes, the possibility can be reduced that the thickness of the liquid crystal material 25 may vary between the areas near the wall-shaped portions 16 and the remaining area in the display region D.

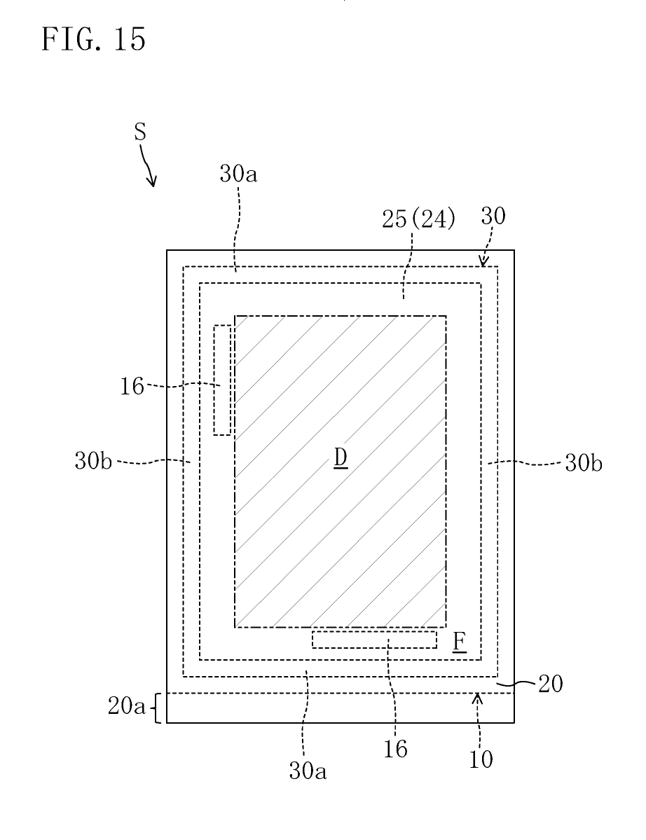

In the first embodiment, the plurality of wall-shaped portions 16 have the pair of first wall-shaped portions 16a facing each other along the first sides 30a of the sealing member 30, and the two pairs of second wall-shaped portions 16b facing each other along the second sides 30b. In the fifth embodiment, the plurality of wall-shaped portions 16 have the two pairs of corner wall-shaped portions 16c that extend in the directions perpendicular to each other along the corners of the sealing member 30. However, the present invention is not limited to this, and the plurality of wall-shaped portions 16 may not be provided in pairs as shown in FIG. 15. For example, if metal interconnects are densely provided in a part of the TFT substrate 20, the wall-shaped portions 16 may be positioned so as to obstruct spreading of the liquid crystal material 24 to the portions of the sealing member 30 where curing is impeded by the metal interconnects blocking UV light for curing the sealing member 30. This configuration also retards spreading of the liquid crystal material 24 to the portions of the sealing member 30 where curing is impeded. Thus, the possibility can be reduced that the liquid crystal material 24 may contact the sealing member 30 before the sealing member 30 is cured by UV radiation, and that vacuum portions in the form of air bubbles may remain in the liquid crystal layer 25 in the display region D.

In the first, second, and fifth embodiments, the upper surfaces of the wall-shaped portions 16 are in contact with the TFT substrate 20. In the third embodiment, the upper surfaces of the wall-shaped portions 16 are in contact with the color filter substrate 10. Thus, the wall-shaped portions 16 are in contact with the opposing substrate in the above embodiments. However, the present invention is not limited to this, and the wall-shaped portions 16 may not be in contact with the opposing substrate. Even if the wall-shaped portions 16 are not in contact with the opposing substrate, the wall-shaped portions 16 obstruct spreading of the liquid crystal material 24 to the portions of the sealing member 30 along which the wall-shaped portions 16 extend. Thus, the possibility can be reduced that the liquid crystal material 24 may contact the uncured sealing member 30, and that the vacuum portions in the form of air bubbles may remain in the liquid crystal layer 25 in the display region D.

In the first, third, and fifth embodiments, the wall-shaped portions 16 are formed simultaneously with the spacers 15. In the second embodiment, the wall-shaped portions 16 are formed simultaneously with the color filters 12r and 12g of the plurality of colors. However, the present invention is not limited to this, and the wall-shaped portions 16 may be formed in a step separate from the steps of forming the spacers 15 and the color filters 12.

In the case where the color filter substrate 10 or the TFT substrate 20 is provided with revets for controlling alignment of the liquid crystal molecules, or in the case where a so-called transflective type LCD device having a reflective region configured to reflect light, and a transmissive region configured to transmit light therethrough is provided with an adjustment layer configured to make the liquid crystal layer thinner in the reflective region than in the transmissive region, it is preferable to form the wall-shaped portions 16 simultaneously with the revets or the adjustment layer. Forming the wall-shaped portions 16 simultaneously with the existing structures can reduce the manufacturing cost, because the number of manufacturing steps is not increased to form the wall-shaped portions 16.

It is described in the above embodiments that the LCD device S is manufactured by performing the sealing member formation step after the wall-shaped portion formation step. However, the present invention is not limited to this, and the LCD device S may be manufactured by performing the wall-shaped portion formation step after the sealing member formation step. That is, the LCD device S may be manufactured by forming the sealing member 30 over the color filter substrate 10 or the TFT substrate 20, forming the wall-shaped portions 16 over the substrate having the sealing member 30 formed thereon, and then sequentially performing the dropping step and the bonding step. Thus, even when the LCD device S is manufactured by performing the wall-shaped portion formation step after the sealing member formation step, the possibility can be reduced that the liquid crystal material 24 may contact the uncured sealing member 30, and that the vacuum portions in the form of air bubbles may remain in the liquid crystal layer 25 in the display region D.

In the above embodiments, the LCD device S is manufactured by bonding the color filter substrate 10 to the TFT substrate 20 via the sealing member 30 having both thermosetting and UV-curable properties. However, the present invention is not limited to this, and the LCD device S may be manufactured by bonding the color filter substrate 10 to the TFT substrate 20 via a sealing member having only the UV-curable property.

### INDUSTRIAL APPLICABILITY

As described above, the present invention is useful for LCD devices and manufacturing methods thereof, and is especially suitable for LCD devices manufactured by an ODF method, for which it is desired to reduce the possibility that a liquid crystal material may contact an uncured sealing member, and that vacuum portions in the form of air bubbles may remain in a liquid crystal layer in a display region, and manufacturing methods thereof.

### DESCRIPTION OF REFERENCE CHARACTERS

S LCD Device
D Display Region
D′ Region to be Display Region
F Non-Display Region
F′ Region to be Non-Display Region
10 Color Filter Substrate
12 Color Filter
12r Red Color Filter
12g Green Color Filter
12b Blue Color Filter
15 Spacer
16 Wall-Shaped Portion
16a First Wall-Shaped Portion
16b Second Wall-Shaped Portion
16c Corner Wall-Shaped Portion
20 TFT Substrate
24 Liquid Crystal Material
25 Liquid Crystal Layer
30 Sealing Member
30a First Side
30b Second Side
31 Seal Region
31a First Side Region
31b Second Side Region

1. A liquid crystal display device, comprising:
first and second substrates placed so as to face each other;
a frame-shaped sealing member provided between the first and second substrates, and configured to bond the first and second substrate together; and
a liquid crystal layer formed by enclosing a liquid crystal material inside the sealing member, where
a display region configured to display an image is defined inside the sealing member, and a non-display region is defined outside the display region, wherein
the non-display region is also provided in an inner periphery of the sealing member, and
the first substrate is provided with a plurality of wall-shaped portions formed in the non-display region in the inner periphery of the sealing member so as to extend along the sealing member and to be separated from each other.

2. The liquid crystal display device of claim 1, wherein
the wall-shaped portions are provided so as to be separated from the sealing member.

3. The liquid crystal display device of claim 1, wherein
the sealing member is formed in a rectangular frame shape, and has a pair of first sides extending in one direction, and a pair of second sides extending in a direction perpendicular to the first sides, and
the plurality of wall-shaped portions have at least one pair of first wall-shaped portions facing each other along the first sides, and at least one pair of second wall-shaped portions facing each other along the second sides.

4. The liquid crystal display device of claim 1, wherein
the sealing member is formed in a rectangular frame shape, and
the plurality of wall-shaped portions have a pair of corner wall-shaped portions extending in directions perpendicular to each other along at least one corner of the sealing member.

5. The liquid crystal display device of claim 1, wherein
upper surfaces of the wall-shaped portions are in contact with the second substrate.

6. The liquid crystal display device of claim 5, wherein
the wall-shaped portions are spacers configured to maintain a thickness of the liquid crystal layer.

7. The liquid crystal display device of claim 1, wherein
the first substrate is provided with a columnar spacer configured to maintain a thickness of the liquid crystal layer, and
the wall-shaped portions are made of a same material as the spacer.

8. The liquid crystal display device of claim 1, wherein
the first substrate is a color filter substrate having color filters of a plurality of colors, and
the wall-shaped portions are formed by stacking the color filters of different colors together.

9. A method for manufacturing a liquid crystal display device including first and second substrates placed so as to face each other, a frame-shaped sealing member provided between the first and second substrates, and configured to bond the first and second substrate together, and a liquid crystal layer formed by enclosing a liquid crystal material inside the sealing member, where a display region configured to display an image is defined inside the sealing member, and a non-display region is defined outside the display region, comprising:
a wall-shaped portion formation step of fabricating the first substrate by forming a plurality of wall-shaped portions over the substrate in which a frame-shaped seal region configured to place the sealing member therein is defined, so that the wall-shaped portions extend along the seal region in a region, which is to be a part of the non-display region, in an inner periphery of the seal region, and are separated from each other;
a sealing member formation step of forming the sealing member in the seal region of the first substrate;
a dropping step of dropping the liquid crystal material onto a region, which is to be the display region, in the first substrate having the wall-shaped portions and the sealing member formed thereon; and
a bonding step of bonding the first and second substrate together via the sealing member and the liquid crystal material, and curing the sealing member.

10. The method of claim 9, wherein
the seal region is defined in a rectangular frame shape, and has a pair of first side regions extending in one direction, and a pair of second side regions extending in a direction perpendicular to the first side regions,
at least one pair of first wall-shaped portions facing each other along the first side regions, and at least one pair of second wall-shaped portions facing each other along the second side regions are formed in the wall-shaped portion formation step, and
the liquid crystal material is dropped onto a region surrounded by the pair of first wall-shaped portions and the pair of second wall-shaped portions in the dropping step.

11. The method of claim 9, wherein
the seal region is defined in a rectangular frame shape,
a pair of corner wall-shaped portions, which extend in directions perpendicular to each other along at least one corner of the seal region, are formed in the wall-shaped formation step, and
the liquid crystal material is dropped onto a region inside the pair of corner wall-shaped portions in the dropping step.
